(19) United States
(12) Patent Application Publication
(10) Pub. No.: US 2017/0039541 A1
(43) Pub. Date: Feb. 9, 2017

(54) POINT-OF-SALE TERMINAL THAT SETS A SPECIAL DISPLAY FLAG IN ELECTRONIC RECEIPT DATA

(71) Applicant: TOSHIBA TEC KABUSHIKI KAISHA, Tokyo (JP)

(72) Inventor: Yuki MATSUMOTO, Izunokuni Shizuoka (JP)

(21) Appl. No.: 15/333,780

(22) Filed: Oct. 25, 2016

Related U.S. Application Data
(63) Continuation of application No. 14/731,863, filed on Jun. 5, 2015.

(30) Foreign Application Priority Data
Jun. 9, 2014 (JP) 2014-118666
Sep. 5, 2014 (JP) 2014-181395

(51) Int. Cl. G06Q 20/20; G07G 5/00

(52) U.S. Cl. CPC G06Q 20/209; G07G 5/00; G06Q 20/202; G06Q 20/322

(57) ABSTRACT

A point-of-sale terminal includes a customer code detecting unit, a control unit, and a communication unit. The control unit is configured to generate electronic receipt data that includes the customer code of a customer who is purchasing one or more products and data describing the products that are being purchased in a transaction, detect a condition for displaying an alert on a mobile computing device correlated to the customer code, and upon detecting the condition, set a flag in the electronic receipt data to indicate that the condition is met. The communication unit is configured to transmit the electronic receipt data that includes the flag to an external apparatus for subsequent transmission to the mobile computing device for display by the mobile computing device.

### CROSS-REFERENCE TO RELATED APPLICATION

This application is a continuation of U.S. patent application Ser. No. 14/731,863, filed on Jun. 5, 2015, which is based upon and claims the benefit of priority from Japanese Patent Application No. 2014-118666, filed Jun. 9, 2014 and Japanese Patent Application No. 2014-181395, filed Sep. 5, 2014; the entire contents of each of these applications are incorporated herein by reference.

### FIELD

An embodiment described herein relates to a point-of-sale (POS) terminal, particularly a POS terminal that sets a flag in electronic receipt data.

### BACKGROUND

One type of an electronic receipt system transmits electronic data of a purchase transaction at a store (i.e., an electronic receipt) to a computing device of a customer, such as a mobile device, instead of a conventional paper receipt that is handed to the customer upon completion of the purchase transaction.

The electronic receipt is useful to the customer, because the customer can manage his or her purchase transactions electronically. Further, the electronic receipt is useful to the store, because the store can reduce paper usage and with full conversion, will not need to invest in machines that issue the paper receipt. In addition, providing electronic receipts instead of paper receipts may reduce the time necessary to carry out settlement processing for the purchase transaction. It would be more convenient to customers if the electronic receipts can notify other information together with the details of the transaction.

### DESCRIPTION OF THE DRAWINGS

FIG. 1 illustrates an entire configuration of an electronic receipt system according to an embodiment.

FIG. 2 is a block diagram a POS terminal in the electronic receipt system.

FIG. 3 is a block diagram of an electronic receipt server in the electronic receipt system.

FIG. 4 is a block diagram of an electronic receipt management server in the electronic receipt system.

FIG. 5 is a block diagram of a mobile terminal in the electronic receipt system.

FIG. 6 illustrates functional blocks generated in the POS terminal for electronic receipt processing.

FIG. 7 schematically illustrates an example of a paper receipt.

FIG. 8 schematically illustrates an example of electronic receipt information.

FIG. 9 is a flowchart illustrating a flow of the electronic receipt processing carried out by the POS terminal.

FIG. 10 is a flowchart illustrating a flow of electronic receipt management processing and information transmission processing carried out by the electronic receipt server.

FIG. 11 illustrates functional blocks generated in the electronic receipt management server for the electronic receipt management processing and the information transmission processing.

FIG. 12 is a flowchart illustrating a flow of the electronic receipt management processing and the information transmission processing carried out by the electronic receipt management server.

FIG. 13 illustrates functional blocks generated in the mobile terminal for electronic receipt reception processing and electronic receipt display processing.

FIG. 14 is a flowchart illustrating a flow of the electronic receipt reception processing and the electronic receipt display processing carried out by the mobile terminal.

FIG. 15 illustrates an example of an electronic receipt displayed on a display unit of the mobile terminal.

### DETAILED DESCRIPTION

In general, according to one embodiment, a point-of-sale terminal includes a customer code detecting unit, a control unit, and a communication unit. The control unit is configured to generate electronic receipt data that includes the customer code of a customer who is purchasing one or more products and data describing the products that are being purchased in a transaction, detect a condition for displaying an alert on a mobile computing device correlated to the customer code, and upon detecting the condition, set a flag in the electronic receipt data to indicate that the condition is met. The communication unit is configured to transmit the electronic receipt data that includes the flag to an external apparatus for subsequent transmission to the mobile computing device for display by the mobile computing device.

Hereinafter, an embodiment will be described with reference to the drawings.

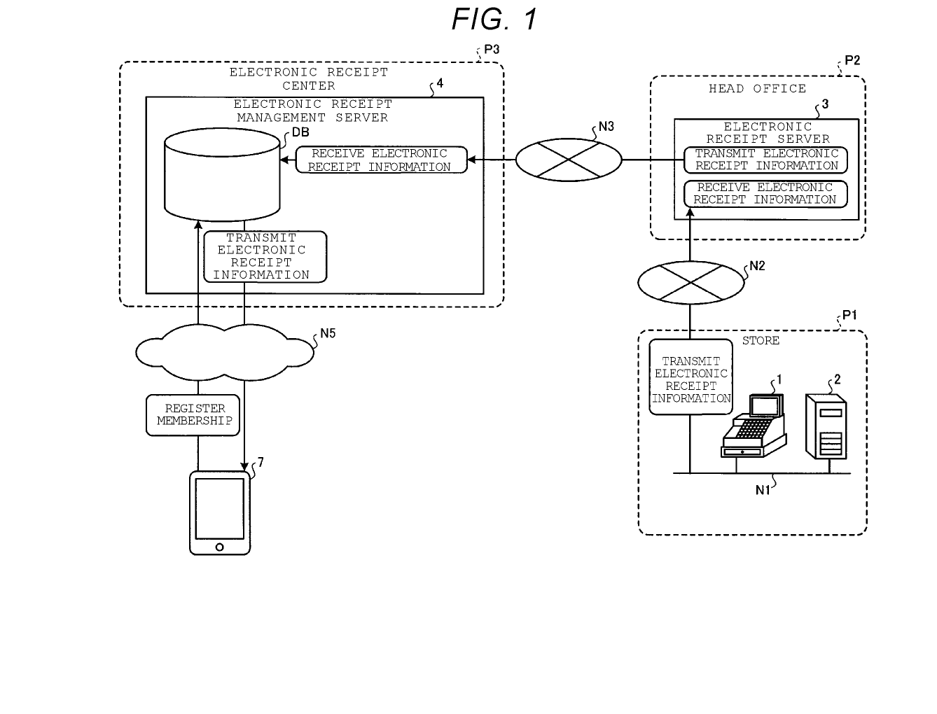

FIG. 1 illustrates an entire configuration of an electronic receipt system according to an embodiment. As illustrated in FIG. 1, the electronic receipt system includes a Point of Sales (POS) terminal 1, a store server 2, an electronic receipt server 3, an electronic receipt management server 4, and a mobile terminal 7.

The POS terminal 1 and the store server 2 are located in a store P1. The POS terminal 1 and the store server 2 are connected to a network N1 such as a Local Area Network (LAN) in the store P1 to be able to communicate with each other. In addition, the POS terminal 1 and the store server 2 are configured to be connected to a network N2 connecting the store P1 and a head office P2, through a network equipment (not illustrated) such as a router which is connected to the network N1 in the store P1. Here, the network N2, for example, is a dedicated line such as the Internet or a Virtual Private Network (VPN).

The POS terminal 1 is a merchandise sales data processing device and performs merchandise sales data processing. The POS terminal 1 generates receipt information (receipt data) including content of a purchase transaction, and outputs a paper receipt by printing the receipt information using a printer 13. In addition, the POS terminal 1 outputs (transmits) electronic receipt information (electronic receipt data), in which a data format of the receipt information has been converted, to the electronic receipt server 3 through the network N2. A transmission method of electronic receipt information is not particularly limited, and a general-purpose protocol such as HTTP or HTTPS may be used. Furthermore, the number of POS terminals 1 in the store P1 is not particularly limited, and a plurality of POS terminals 1 may be provided.

The store server 2 integrally performs management of operations, such as the merchandise sales data processing, which are performed by the POS terminal 1. For example, the store server 2 stores and manages merchandise sales data which is generated through the merchandise sales data processing in the POS terminal 1, or stores and manages a merchandise data file or the like which is used during the merchandise sales data processing.

Furthermore, in the present embodiment, the POS terminal outputs the electronic receipt information, but the configuration is not limited thereto. For example, the data format of the receipt information generated by the POS terminal 1 maybe converted by the store server 2 or a conversion device (not illustrated), and the receipt information may be output to the electronic receipt server 3 as the electronic receipt information.

The electronic receipt server 3 is located in the head office P2 of a company which operates one or more stores or chain stores, and functions as a receipt management server for the company. The electronic receipt server 3, for example, has a function to perform operations such as sales management, sales analysis, and inventory management of the company operating the store.

The electronic receipt server 3 receives the electronic receipt information transmitted from the POS terminal 1 through the network N2. In addition, the electronic receipt server 3 transmits the received electronic receipt information to the electronic receipt management server 4 through a network N3 that connects the head office P2 and an electronic receipt center P3.

Here, the network N3, for example, is a dedicated line such as the Internet or VPN. In addition, a transmission method of electronic receipt information is not particularly limited, and a general-purpose protocol such as HTTP or HTTPS may be used.

The electronic receipt management server 4 is located in the electronic receipt center P3. The electronic receipt center P3, for example, is a third-party organization other than the company managing the electronic receipt information using the electronic receipt server 3. Alternatively, the third-party organization or the like may also manage the electronic receipt server 3.

The electronic receipt management server 4 functions as a receipt management server for customer and collectively manages the electronic receipt information of multiple companies each of which operates one or more stores. The electronic receipt management server 4 stores membership data such as a name or a member code (reception destination code) of each customer (member) who has completed membership registration, and transmission destination information (for example, an email address) associated with the mobile terminal 7, which is a transmission destination of the electronic receipt information stored in a membership master maintained in database DB, and manages the data. Furthermore, a membership management server or the like which stores and manages the membership data may be provided separately from the electronic receipt management server 4.

In addition, the electronic receipt management server receives the electronic receipt information from the electronic receipt server 3 through the network N3, stores the electronic receipt information in an electronic receipt management region 43a maintained in the database DB, and manages the electronic receipt information. More specifically, the electronic receipt information includes information such as a member code in addition to the content (merchandise sales data) of the purchase transaction, and is managed in correlation with the membership data of the corresponding member.

When the electronic receipt information is stored in the database DB, the electronic receipt management server 4 specifies the transmission destination (the mobile terminal 7) by reference to the transmission destination information correlated with the member code of the electronic receipt information. Then, the electronic receipt management server 4 transmits the electronic receipt information stored in the database DB to the transmission destination through a network N5.

When an inquiry of the electronic receipt information designating a specific member code is received from the mobile terminal 7, which is connected through the network N5, the electronic receipt management server 4 extracts the electronic receipt information corresponding to the member code from the database DB, and transmits the electronic receipt information to the mobile terminal 7.

The mobile terminal 7 is a terminal device such as a smart phone, a mobile phone, Personal Digital Assistant (PDA), or a tablet computer which is used by a user (customer) of the electronic receipt system. The mobile terminal 7 implements an application such as a Web browser for displaying various kinds of information uploaded on the network N5. Furthermore, a terminal device such as PC may be used instead of the mobile terminal 7.

The mobile terminal 7 accesses the electronic receipt management server 4 through the network N5, and performs the membership registration with respect to the electronic receipt system. Here, the network N5 is the Internet or various public networks.

Here, the membership registration of the customer in the electronic receipt system, for example, is performed according to the following procedure. The customer transmits a blank mail to the electronic receipt management server 4 from the mobile terminal 7 through the network N5. The electronic receipt management server 4 transmits a Uniform Resource Locator (URL) of a webpage for the membership registration to the received email address. The customer accesses the webpage for the membership registration from the mobile terminal 7, and displays an input screen to which items (a name, transmission destination information, and the like) necessary for the membership registration are input. After terminating the input of the necessary item by the customer, the electronic receipt management server 4 performs the membership registration with respect to the membership master. After that, the electronic receipt management server 4 delivers a membership registration completion mail including a member code (customer code) and a password to the mobile terminal 7. As a result, the membership registration is completed.

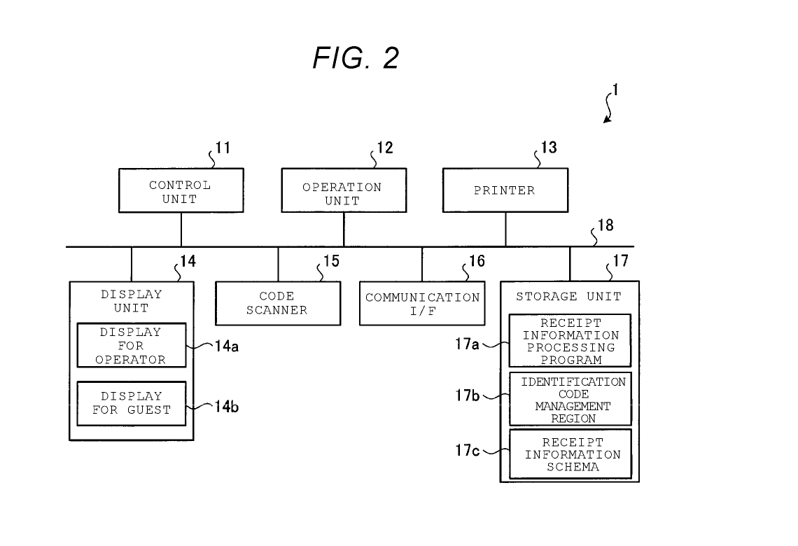

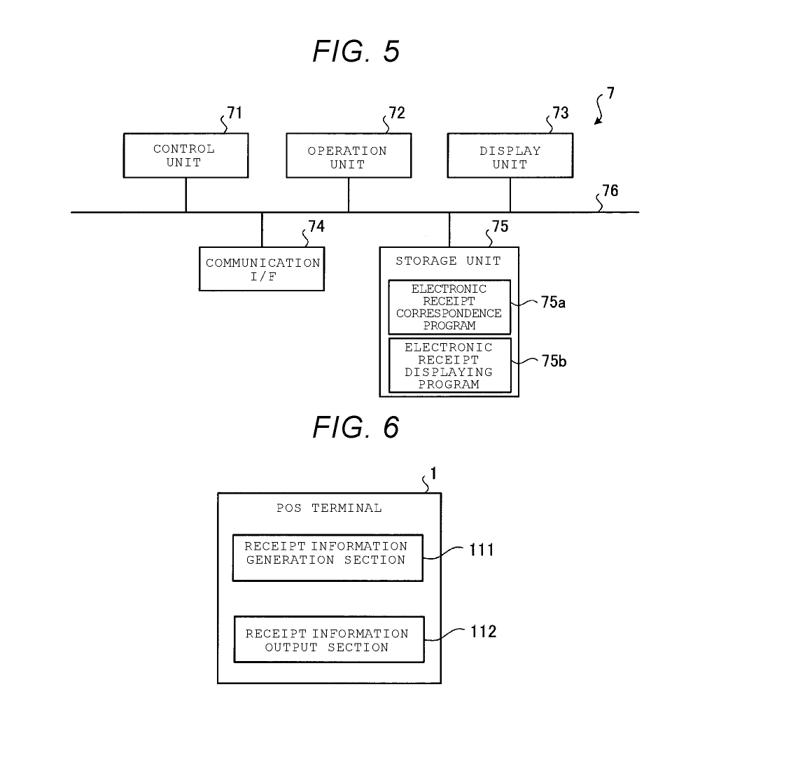

After the membership registration as described above, the mobile terminal 7 displays the member code of the customer (receipt destination code) on a display unit 73 (refer to FIG. 5) as a code symbol such as a bar code or a two-dimensional code. The customer exhibits the code symbol displayed on the mobile terminal 7 to a salesperson during the purchase transaction in the store P1. The salesperson scans the code symbol displayed on the mobile terminal 7 by a code scanner 15 (refer to FIG. 2) connected to the POS terminal 1. As a result, the member code (a reception destination code) of the customer is able to be correlated with the electronic receipt information generated after the payment through the merchandise sales data processing in the POS terminal 1.

In addition, after the payment (the transaction) in the POS terminal 1, the mobile terminal 7 receives the electronic receipt information of the purchase transaction, which is transmitted from the electronic receipt management server 4 through the network N5. The inquiry of the electronic receipt information designating the member code may be transmitted to the electronic receipt management server 4 through the network N5, and then the electronic receipt information of the membership may be received from the electronic receipt management server 4. In addition, the mobile terminal 7 displays the received electronic receipt information on the display unit 73.

In the electronic receipt system according to the present embodiment, the electronic receipt information indicating the content of the purchase transaction (payment) generated through the merchandise sales data processing by the POS terminal 1 of the store P1 is transmitted to the electronic receipt management server 4 through the electronic receipt server 3, and is uploaded on the Web. By implementing the Web browser and designating the Uniform Resource Locator (URL), the mobile terminal 7 can download the electronic receipt information uploaded on the Web and display the electronic receipt on the Web browser. Furthermore, a different application for displaying the electronic receipt on the mobile terminal 7 may be installed and displayed.

Next, the configuration of main devices configuring the electronic receipt system according to the present embodiment will be described.

First, the POS terminal 1, which is the merchandise sales data processing device, will be described. FIG. 2 is a block diagram of the POS terminal 1. As illustrated in FIG. 2, the POS terminal 1 includes a control unit 11 which integrally controls various calculations or each unit of the POS terminal 1. The control unit 11 includes a Central Processing Unit (CPU), a Read Only Memory (ROM) storing various programs or data items, a Random Access Memory (RAM) that temporarily stores various programs or rewritably stores various data, a Real Time Clock (RTC) unit that indicates current date and time, and the like.

The control unit 11 is connected to an operation unit 12, a printer 13, a display unit 14, and a code scanner 15, through a bus 18.

The operation unit 12 includes various operation keys with which an operator performs input operations. The operation keys include, for example, a register key for inputting a numerical value, a cursor key for selecting a predetermined item, a selection determination key, a subtotal key indicating total price of the merchandise for which sales registration has been performed, a settlement key for closing one purchase transaction, and the like.

The printer 13 is a printer device printing the receipt, a journal, or the like. The printer 13 includes a cutting mechanism (not illustrated) to cut paper such as rolled paper which is a printing target, and cuts the paper according to a cut command.

The display unit 14, for example, is a liquid crystal display or the like, and displays various kinds of information such as name of the merchandise subjected to the sales registration, the price, a total price of one transaction, and a change sum. The display unit 14 includes a display 14a for an operator which displays various information items to a cashier, and a display 14b for a guest which displays various information items to the customer. Furthermore, the display unit 14 may have a touch panel, and in this case, the touch panel functions as the operation unit 12.

The code scanner 15 is a scanner device and optically reads the code symbol such as a bar code or a two-dimensional code. The code scanner 15, for example, reads a code symbol printed on the merchandise, a code symbol displayed on the mobile terminal 7, or the like, and outputs information contained in the read code symbol to the control unit 11. Furthermore, in the code symbol printed on the merchandise, a merchandise code for specifying the merchandise or the like is contained. In addition, in the code symbol displayed on the mobile terminal 7, a member code (customer code) for identifying the customer carrying the mobile terminal 7 or the like is contained.

In addition, the control unit 11 is connected to a communication I/F (interface) 16 through the bus 18, and is configured to be connected to the network N1 or the network N2 in the store P1 through the communication I/F 16.

Further, the control unit 11 is connected to the storage unit 17 through the bus 18. The storage unit 17 is, for example, an auxiliary storage device such as Hard Disk Drive (HDD) or Solid State Drive (SSD). The storage unit 17 stores a program for performing various POS operations including the merchandise sales data processing. In addition, the storage unit 17 stores various data files related to the merchandise sales data processing such as a merchandise data file in which the merchandise data such as the merchandise name of each of the merchandise, the merchandise code, and the unit price is stored, or a point file. In addition, the storage unit 17 stores a receipt information processing program 17a for performing the merchandise sales data processing or processing related to the receipt information.

The merchandise data file stores the maximum number of products that are allowed to be purchased or special sale information, with respect to each product. In addition, the point file stores an expiration date of reward points correlated with the member code.

In addition, the storage unit 17 stores a POS number for identifying the own POS terminal 1, a company code (identification code of the company which operates the store), a business type and business category code, a store code of the store P1 in which the POS terminal 1 is located, and the like, in an identification code management region 17b. Here, the business type and business category code is, for example, a code (sort code) specifying the business type and business category of the store such as a convenience store, a pharmacy, a restaurant, and the like. Furthermore, this business type and business category is able to be arbitrarily changed according to the preference of the user. Further, the company code (the identification code of the company which operates the store) and the business type and business category code may also be registered in the electronic receipt server 3.

In addition, the storage unit 17 stores a receipt information schema 17c that defines the convert rules, which is used to convert the receipt information in a non-structured format into the electronic receipt information in a structured format.

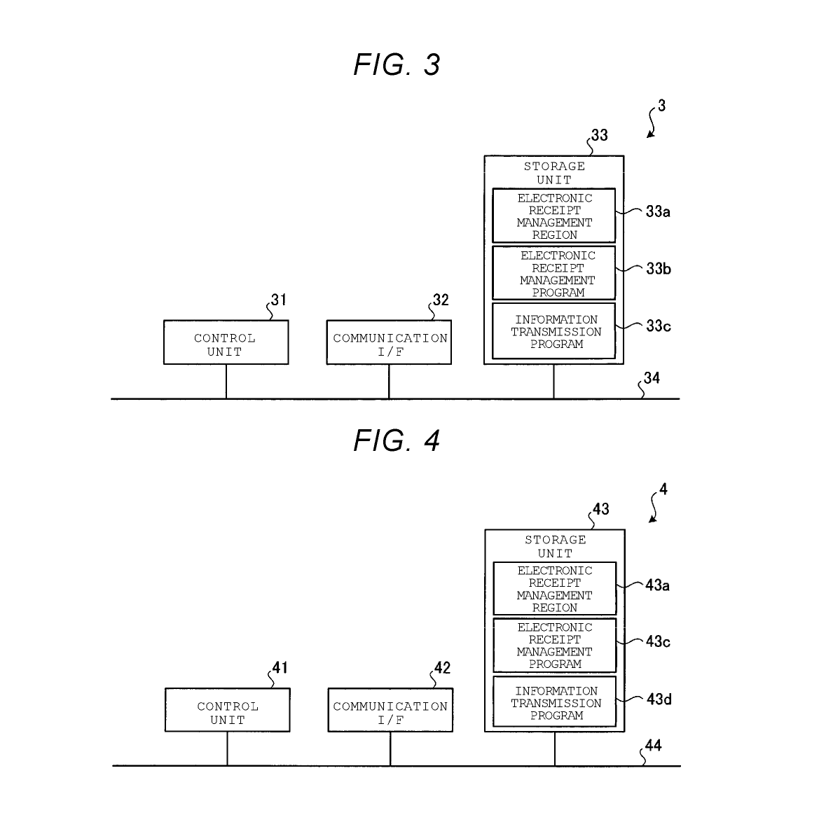

Next, the configuration of the electronic receipt server 3, which functions as a receipt management server for a company, will be described with reference to a block diagram of FIG. 3. The electronic receipt server 3 includes a control unit 31 which integrally controls various calculations or each unit of the electronic receipt server 3. The control unit 31 includes a CPU, a ROM storing various programs or data items, a RAM that temporarily stores various programs or rewritably stores various date items, an RTC unit that indicates current date and time, and the like.

The control unit 31 is configured to be connected to the network N2 or the network N3 through the communication I/F 32 connected to a bus 34. The control unit 31 is also connected to the storage unit 33 through the bus 34.

The storage unit 33 stores the electronic receipt information of a company which operates one or more stores in an electronic receipt management region 33a. The electronic receipt information includes the company code (identification code of the company), the business type and business category code, the store code, the member code of the shopper, one or more POS numbers of the POS terminals 1, the receipt numbers, the merchandise sales data, and the like.

In addition, the storage unit 33 stores an electronic receipt management program 33b for managing the electronic receipt information stored in the electronic receipt management region 33a. In addition, the storage unit 33 stores an information transmission program 33c for transmitting the electronic receipt information stored in the electronic receipt management region 33a to the electronic receipt management server 4.

Next, the configuration of the electronic receipt management server 4, which functions as a receipt management server for a customer, will be described with reference to a block diagram of FIG. 4. As illustrated in FIG. 4, the electronic receipt management server 4 includes a control unit 41 which integrally controls various calculations or each unit of the electronic receipt management server 4. The control unit 41 includes a CPU, a ROM storing various programs or data items, a RAM that temporarily stores various programs or rewritably stores various data items, an RTC unit that indicates current date and time, and the like.

The control unit 41 is configured to be connected to the network N3 and the network N5 through a communication I/F 42 connected to a bus 44. The control unit 41 is also connected to a storage unit 43 through the bus 44.

The storage unit 43 contains the electronic receipt management region 43a for collectively storing the electronic receipt information of multiple companies each of which operate one or more stores, in addition to a membership master management region (not illustrated) for storing and managing the membership master. More specifically, the electronic receipt management region 43a is used to manage the electronic receipt information of the multiple companies, with respect to each member code.

The electronic receipt information includes the member code, the company code (the identification code of the company which operates the store), the store code, the POS number of the POS terminal 1, the receipt number, the merchandise sales data (including date and time data), and the like. A consumer goods manufacturer or the like is able to acquire a purchase proof of merchandise associated with the manufacturer from the electronic receipt information, in accordance with specific conditions (for example, a specific company which operates the store, a specific location, a specific time, and the like). Furthermore, the consumer goods manufacturer is a manufacturer of food, drink, clothing, cosmetics, drug, house hold goods, and the like.

In addition, the storage unit 43 stores an electronic receipt management program 43c for managing the electronic receipt information of each company stored in the electronic receipt management region 43a, in addition to a membership management program (not illustrated) for managing the membership master by a membership master region. The storage unit 43 also stores an information transmission program 43d for transmitting the electronic receipt information to the mobile terminal 7. Furthermore, the membership master management region and the electronic receipt management region 43a correspond to the database DB illustrated in FIG. 1.

Next, the configuration of the mobile terminal 7 will be described with reference to a block diagram of FIG. 5. As illustrated in FIG. 5, the mobile terminal 7 includes a control unit 71 which integrally controls various calculations or each unit of the mobile terminal 7. The control unit 71 includes a CPU, a ROM storing various programs or data items, a RAM that temporarily stores various programs or rewritably stores various data items, an RTC unit that indicates current date and time, and the like.

The control unit 71 is connected to an operation unit 72 and a display unit 73 through a bus 76. The operation unit includes various operation keys with which the user (customer) performs input operations, or a pointing device. The display unit 73, for example, is a liquid crystal display or the like, and displays various kinds of information including the electronic receipt information. Furthermore, the display unit 73 may have a touch panel, and in this case, the touch panel functions as the operation unit 72.

In addition, the control unit 71 is connected to a communication I/F 74 through the bus 76, and is configured to be connected to the network N5 through the communication I/F 74. Furthermore, the control unit 71 may be connected to the network N1 in the store P1 through the communication I/F 74.

The control unit 71 is also connected to a storage unit 75 through the bus 76. The storage unit 75 stores an electronic receipt correspondence program 75a for receiving the electronic receipt information from the electronic receipt management server 4, and an electronic receipt displaying program 75b for displaying the received electronic receipt information, in addition to the Web browser for displaying various kinds of information (content) uploaded on the Web.

Next, an operation of each unit configuring the electronic receipt system of the present embodiment will be described.

First, electronic receipt processing which is performed when the control unit 11 of the POS terminal 1 executes the receipt information processing program 17a will be described with reference to FIG. 6 to FIG. 9.

As illustrated in FIG. 6, when the receipt information processing program 17a is executed by the POS terminal 1, modules including a receipt information generation section 111 and a receipt information output section 112. As actual hardware, the CPU of the control unit 11 reads the receipt information processing program 17a from the storage unit 17 and executes the programs, and thus each of the sections described above is loaded on the RAM, and the receipt information generation section 111 and the receipt information output section 112 are generated on the RAM.

Here, the receipt information generation section 111 is a functional unit corresponding to an existing application and mainly performs the merchandise sales data processing and generation of data (receipt information) for printing of the receipt. When the receipt information generation section 111 acquires merchandise code specifying the merchandise through the code scanner 15, the merchandise data corresponding to the merchandise code is read from the merchandise data file, and calculation of the price is performed based on the unit price included in the merchandise data. Then, the receipt information generation section 111 generates the merchandise sales data processed during the merchandise sales data processing, that is, the receipt information including the content of the purchase transaction.

In addition, when the receipt information generation section 111 acquires the member code specifying the customer scanned by the code scanner 15 at any timing during one transaction, the member code is included in the receipt information.

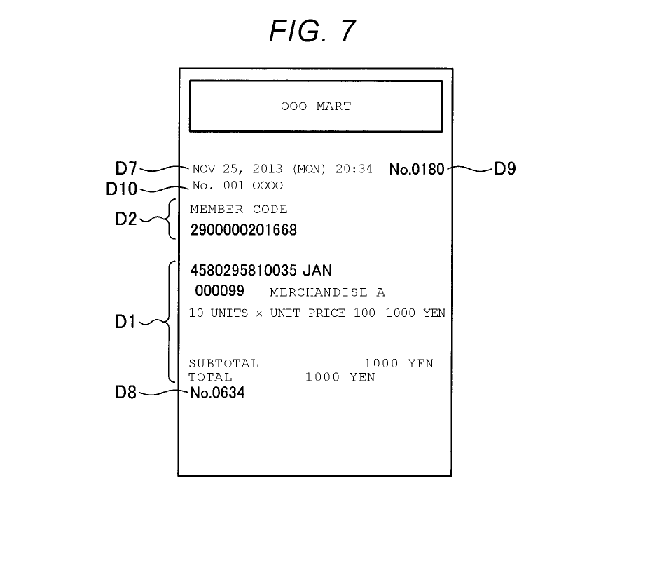

FIG. 7 illustrates an example of a paper receipt corresponding to the receipt information. Here, the receipt information is text data in a non-structured format, and is used for the printing by the printer 13. As illustrated in FIG. 7, the paper receipt includes merchandise sales data D1 and a member code D2 described above. Here, the merchandise sales data D1 may include a merchandise name (merchandise code) of the merchandise which is a payment target, and a price thereof, a total price of the merchandise, an amount deposited by the customer, amount of change, and the like.

In addition, the paper receipt includes transaction date and time D7, a transaction number (receipt number) D8, a cash register number D9, and a name of a person in charge D10. Furthermore, elements included in the paper receipt are not limited to an example of FIG. 7, and may include other elements such as a company code (company name) of a company which operates the store, a store code (store name), a telephone number of the store, an address, and a business type and business category code.

In addition, when the settlement key is pressed, the receipt information generation section 111 determines that the merchandise sales data processing for one purchase transaction has been completed, and outputs (issues) the generated receipt information to the receipt information output section 112 along a cut command. Here, the cut command is one of printer control commands which are generally used, and instructs cutting of the paper on which the receipt information is printed. Furthermore, the receipt information may be collectively generated after the settlement key is pressed, or may be sequentially generated each time the merchandise code or the customer code is acquired.

The receipt information output section 112 determines an output destination of the receipt information each time the receipt information for one purchase transaction is generated by the receipt information generation section 111. More specifically, when the cut command is issued by the receipt information generation section 111, the receipt information output section 112 determines that the receipt information for one purchase transaction is generated. Then, the receipt information output section 112 determines whether or not the member code is included in the generated receipt information, and outputs the receipt information to the output destination according to a determination result thereof.

Specifically, when it is determined that the member code is not included in the receipt information, the receipt information output section 112 outputs the receipt information to the printer 13 along with the cut command. Accordingly, the receipt information is printed on the paper by the printer 13, and then the paper is cut according to the cut command. As a result, the paper receipt for one transaction is printed out. Furthermore, during the printing, all elements of the receipt information may be printed, or may be printed after removing the member code or the like or by adding the other information such as advertisement.

In addition, when it is determined that the member code is included in the receipt information, the receipt information output section 112 converts the format of the receipt information into a predetermined data format according to the conversion rules of the receipt information schema 17c. Then, the receipt information output section 112 transmits (outputs) the receipt information of which the data format has been converted, that is, the electronic receipt information, to the electronic receipt server 3 which performs management of the company associated with the company code.

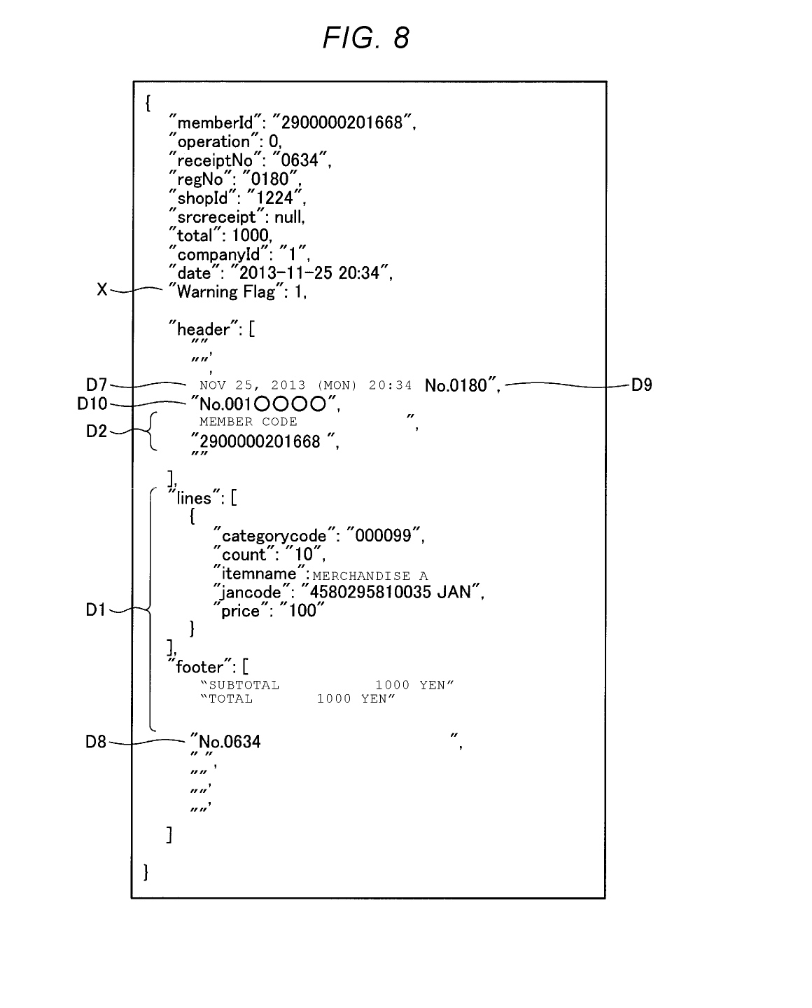

Here, FIG. 8 schematically illustrates an example of the electronic receipt information. As illustrated in FIG. 8, the electronic receipt information includes data in a structured format (structured document) such as XML, CSV, and JavaScript (registered trademark) Object Notation (JSON). Furthermore, in FIG. 8, the format of each element of the receipt information (D1 and D2, and D7 to D10) is converted into a JSON format.

The conversion from the receipt information into the electronic receipt information is performed based on the conversion rules described in the receipt information schema 17c. Specifically, in the receipt information schema 17c, a predetermined element configuring the receipt information and property information (tag or the like) indicating properties of the element are defined. The receipt information output section 112 structures each element of the receipt information using the corresponding property information, and then generates the electronic receipt information in a structured format as illustrated in FIG. 8. By setting the electronic receipt information to have a structured format, it is possible to more conveniently use the element included in the electronic receipt information, and obtain various advantages on the data management.

In addition, the receipt information output section 112 checks whether or not a notification related to a predetermined element in the receipt information is necessary during the conversion from the receipt information into the electronic receipt information. As a specific example of checking whether or not the notification related to the predetermined element in the receipt information is necessary, the following is included.
Expiration of Reward Points
Discount Purchase
Operation Mistake of Cashier

For example, the operation mistake of the cashier occurs when the cashier registers incorrect number (e.g., greater than actual number) of the merchandise. When the number of the merchandise registered and included in the electronic receipt information exceeds a maximum number set for the merchandise, which is obtained by reference to the merchandise data file, the receipt information output section 112 determines that the operation mistake of the cashier occurs. For example, as illustrated in FIG. 7, if an actually purchased amount is “1” but the amount is registered as “10” by the operation mistake of the cashier, when the maximum number of purchases is “5”, the receipt information output section 112 determines that the operation mistake of the cashier occurs and the notification is necessary.

In addition, when the expiration date of reward points correlated with the member code, which is obtained by reference to the reward points stored in the point file, is within one month, the receipt information output section 112 determines that the expiration date is approaching and the notification is necessary.

In addition, when the merchandise included in the electronic receipt information is found out to be on special sale by reference to the special sale information stored in the merchandise data file, the receipt information output section 112 determines that it is the discount purchase and the notification is necessary.

When a check result of the predetermined element in the receipt information as described above is positive (when it is determined that the notification is necessary), the receipt information output section 112 adds (validates) a flag X for notification (alarm) to the electronic receipt information. Furthermore, the flag X for notification may be added in association with the predetermined element for which the notification is necessary.

Thus, the receipt information output section 112 determines that the receipt information of one purchase transaction is generated by detecting the cut command issued by the receipt information generation section 111, and starts to output the receipt information. Accordingly, it is not necessary to notify a dedicated signal for indicating the termination of one purchase transaction to the receipt information output section 112 from the receipt information generation section 111. As a result, without changing the receipt information generation section 111 corresponding to the existing application, it is possible to output the receipt information of one purchase transaction by the receipt information output section 112. In addition, as the receipt information generation section 111 does not need to be modified, it is possible to achieve an output function of the electronic receipt information using the existing application.

In addition, the receipt information output section 112 determines the output destination of the receipt information according to whether or not the member code is included in the receipt information. Accordingly, it is possible to output the paper receipt or the electronic receipt information without preparing necessary/unnecessary information of the paper receipt for each customer, and thus it is possible to efficiently determine the output destination of the receipt information. In addition, for example, the customer (member) may select the output of the paper receipt or the electronic receipt information based on input of a member code, and it is possible to improve convenience of the customer.

Further, when the receipt information is output to the electronic receipt server 3, the receipt information output section 112 converts the electronic receipt information in a structured format into the electronic receipt information, and outputs the electronic receipt information. As a result the element in the electronic receipt information is able to be more conveniently used by the electronic receipt server 3 and the electronic receipt management server 4 managing the electronic receipt information, or the mobile terminal 7 displaying the electronic receipt.

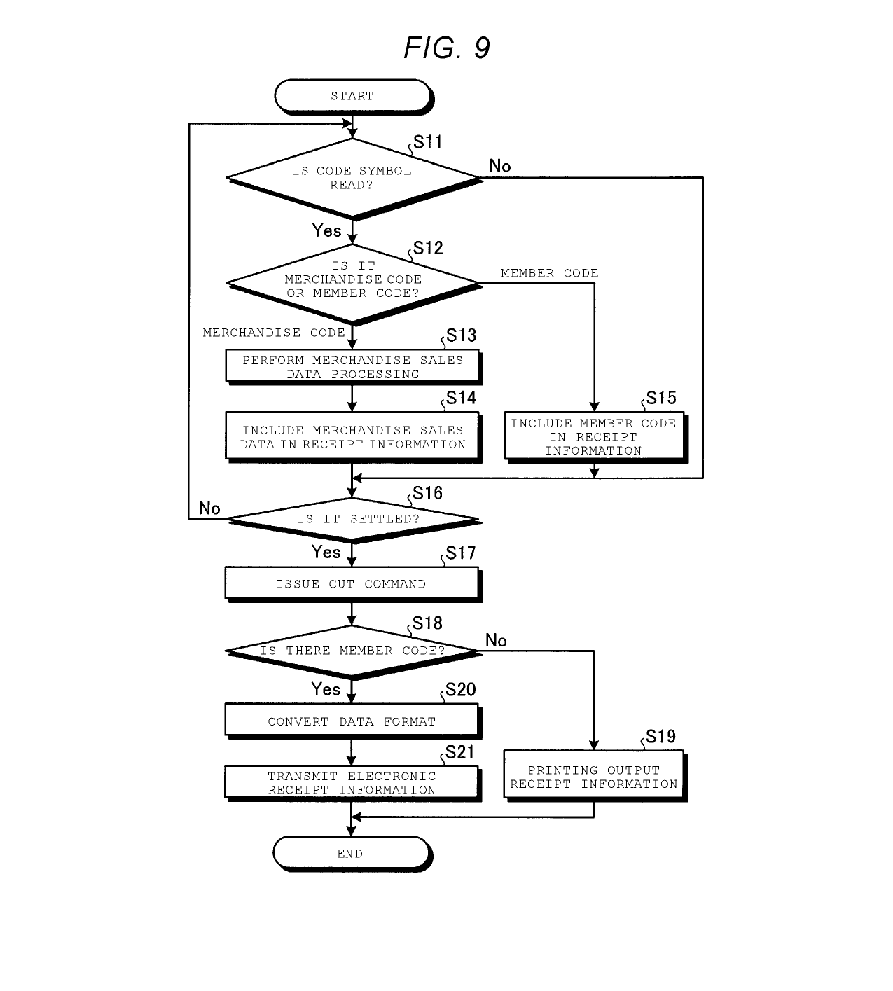

FIG. 9 is a flowchart illustrating a flow of the electronic receipt processing carried out by the POS terminal 1. First, the receipt information generation section 111 of the POS terminal 1 determines whether or not the code symbol (merchandise code) printed on the merchandise or the code symbol (member code) displayed on the mobile terminal 7 are read by the code scanner 15 (Step S11). When the code symbol is not read (Step S11; No), the receipt information generation section 111 proceeds to Step S16.

In contrast, when it is determined that the code symbol is read (Step S11; Yes), the receipt information generation section 111 determines whether the information acquired is the merchandise code or the member code (Step S12).

In Step S12, when the merchandise code is acquired (Step S12; merchandise code), the receipt information generation section 111 reads the merchandise data from the merchandise data file with respect to the merchandise specified by the merchandise code, and calculation of the price is performed based on the unit price included in the merchandise data (Step S13). Subsequently, the receipt information generation section 111 generates the receipt information including the merchandise sales data which is processed during the merchandise sales data processing (Step S14).

When the member code is acquired in Step S12 (Step S12; member code), the receipt information generation section 111 generates the receipt information including the member code (Step S15).

Here, in order to input the member code into the POS terminal 1, for example, the customer (member) displays the code symbol of the member code or the like on the display unit 73 of the mobile terminal 7, and the salesperson or the customer scans the code symbol using the code scanner 15 of the POS terminal 1. Furthermore, the receipt information generation section 111 may perform exclusive processing or the like such that only one member code is associated with the purchase transaction, even if more than two member codes are input.

Subsequently, in Step S16, the receipt information generation section 111 determines whether or not the start of the settlement processing is instructed by pressing of the settlement key or the like (Step S16). When the start of the settlement processing is not instructed (Step S16; No), the receipt information generation section 111 returns to Step S11. When the start of the settlement processing is instructed (Step S16; Yes), the receipt information generation section 111 issues (outputs) the cut command to the receipt information output section 112 (Step S17).

When the cut command is received from the receipt information generation section 111, the receipt information output section 112 determines that the receipt information of one purchase transaction is generated, and determines whether or not the member code is included in the receipt information (Step S18).

When the member code is not included in the receipt information (Step S18; No), the receipt information output section 112 outputs the receipt information of the purchase transaction to the printer 13 along with the cut command, such that the receipt information is printed out (Step S19), and terminates the processing. Then, the printer 13 prints out the receipt information on paper, and then the paper is cut according to the cut command. As a result, the paper receipt of one purchase transaction is printed out.

In contrast, when the member code is included in the receipt information (Step S18; Yes), the receipt information output section 112 generates the electronic receipt information by converting the data format of the receipt information, which is a non-structured format, into a structured format (Step S20).

Furthermore, the receipt information output section 112 checks whether or not the notification related to the predetermined element in the receipt information is necessary during the conversion from the receipt information into the electronic receipt information. When the notification related to the predetermined element is necessary, the receipt information output section 112 adds (validates) the flag X for notification (alarm) to the electronic receipt information.

Then, the receipt information output section 112 transmits the generated electronic receipt information to the electronic receipt server 3 through the communication I/F 16 (Step S21), and terminates the processing.

In the processing described above, when the member code is included in the receipt information, the receipt information is output to the electronic receipt server 3, but the configuration is not limited thereto. For example, the receipt information may be output to both of the printer 13 and the electronic receipt server 3.

In addition, when the member code is included in the receipt information, the output destination of the receipt information may be selected. For example, the mobile terminal 7 may maintain output classification information designating the output destination of the receipt information in the code symbol, and may instruct the output destination based on the output classification information in the code symbol. In this case, the receipt information generation section 111 includes the output classification information read by the code scanner 15 in the receipt information along with the member code. When the receipt information output section 112 determines that the member code is included in the receipt information, and that the output classification information exists, the output destination of the receipt information is determined based on the output classification information. Here, any one or both of the printer 13 and the electronic receipt server 3 are able to be designated in the output classification information.

In addition, the output destination of the receipt information may be selected each time the payment of the merchandise is performed. In this case, for example, when it is determined that the member code is included in the receipt information, the receipt information output section 112 displays an output destination selection screen for selecting the output destination of the receipt information on the display unit 14.

Furthermore, the display of the selection screen is not limited to the display 14a for an operator, and the selection screen may be displayed on the display 14b for a guest. In addition, when the display 14b for a guest has a touch panel configuration, the customer may select the output destination on the screen.

In addition, the customer may select the output destination of the receipt information during the merchandise sales data processing. In this case, the receipt information generation section 111 displays the output destination selection screen or the like on the display unit 14, and includes the output destination corresponding to an operated key in the receipt information as the output classification information. When the member code and the output classification information are included in the receipt information, the receipt information output section 112 determines the output destination of the receipt information based on the output classification information.

As described above, when the member code is included in the receipt information, the receipt information output section 112 automatically selects the output destination of the receipt information, or receives manual selection of the output destination. Accordingly, it is possible to flexibly set a determination method of the output destination.

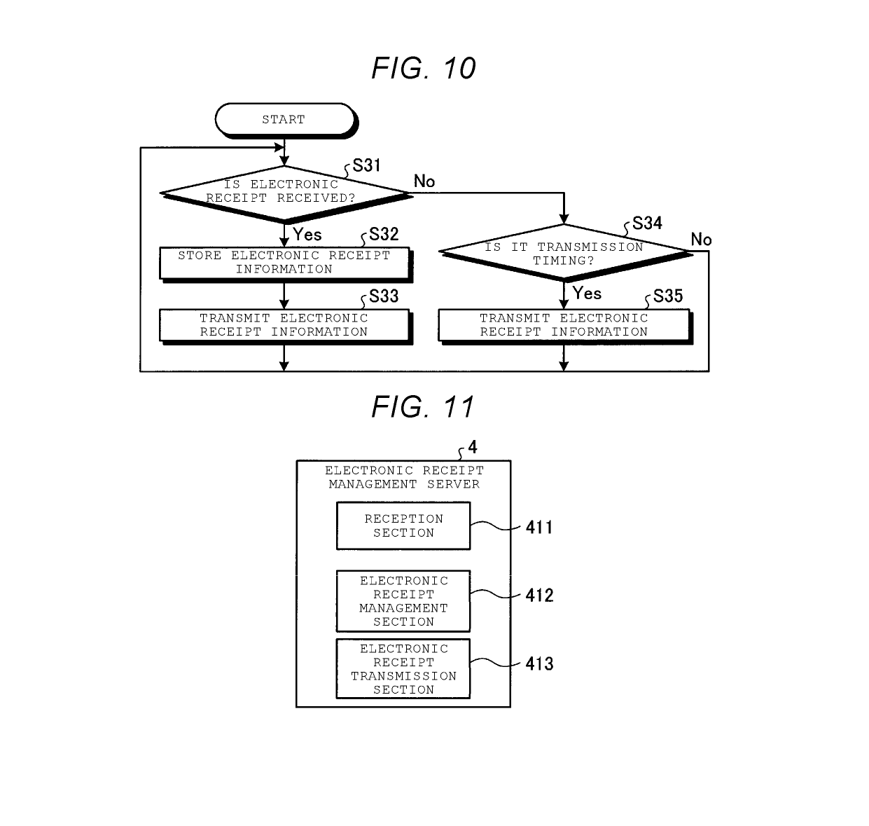

Next, a flow of the electronic receipt management processing which is performed when the control unit 31 of the electronic receipt server 3 executes the electronic receipt management program 33b and a flow of the information transmission processing which is performed when the control unit 31 of the electronic receipt server 3 executes the information transmission program 33c will be described with reference to a flowchart illustrated in FIG. 10.

When the electronic receipt information transmitted from the POS terminal 1 is received through the communication I/F (Step S31; Yes), the control unit 31 of the electronic receipt server 3 stores the electronic receipt information in the electronic receipt management region 33a of the storage unit 33 as the electronic receipt information of the corresponding company (Step S32). Then, the control unit 31 of the electronic receipt server 3 transmits the electronic receipt information stored in Step S32 to the electronic receipt management server 4 (Step S33), and returns to Step S31.

In addition, at a transmission timing which is set in advance (Step S31; No→Step S34; Yes), the control unit 31 of the electronic receipt server 3 transmits the electronic receipt information which is stored and managed in the electronic receipt management region 33a to the electronic receipt management server 4 (Step S35), and returns to Step S31. According to the transmission in Step S35, for example, the electronic receipt information which is out of a transmission target in Step S33 is able to be transmitted to the electronic receipt management server 4. Furthermore, in Step S35, the transmission may be controlled such that only the electronic receipt information which is not successfully transmitted is transmitted.

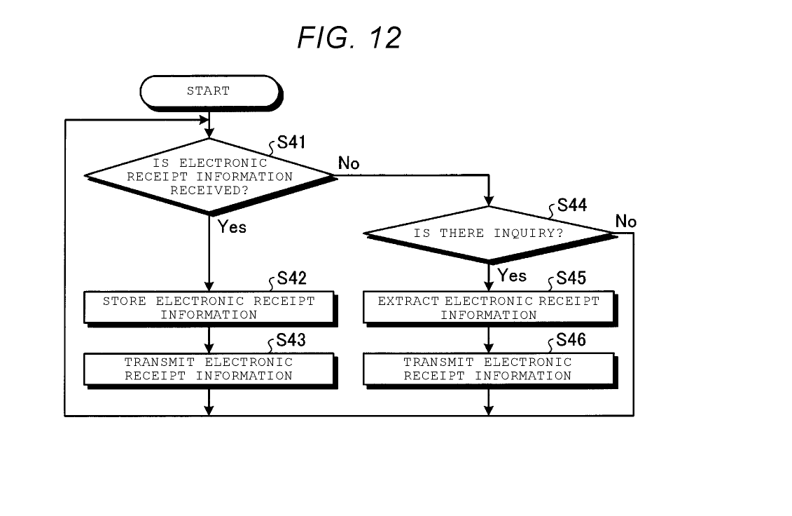

Next, a flow of the electronic receipt management processing which is performed when the control unit 41 of the electronic receipt management server 4 executes the electronic receipt management program 43c and a flow of the information transmission processing which is performed when the control unit 41 of the electronic receipt management server 4 executes the information transmission program 43d will be described with reference to a functional block diagram illustrated in FIG. 11 and a flowchart illustrated in FIG. 12.

As illustrated in FIG. 11, when the electronic receipt management program 43c and the information transmission program 43d which are executed by the electronic receipt management server 4, modules including a reception section 411, an electronic receipt management section 412, and an electronic receipt transmission section 413 are generated. As actual hardware, the CPU of the control unit 41 reads the electronic receipt management program 43c and the information transmission program 43d from the storage unit 43 and executes the programs, and as a result each of the sections described above is loaded on the RAM, and the reception section 411, the electronic receipt management section 412, and the electronic receipt transmission section 413 are generated on the RAM.

The reception section 411 receives the electronic receipt information which includes the company code indicating the company which operates the store and is electronically processed during the merchandise sales data processing, from the electronic receipt server 3.

The electronic receipt management section 412 stores and manages the electronic receipt information received by the reception section 411 in the electronic receipt management region 43a of the storage unit 43, with respect to each company.

The electronic receipt transmission section 413 acquires the electronic receipt information including one or more company codes in correlation with the member code from the electronic receipt management region 43a and transmits the electronic receipt information to the mobile terminal 7 correlated with the member code.

As illustrated in FIG. 12, the reception section 411 of the electronic receipt management server 4 determines whether or not the electronic receipt information transmitted from the electronic receipt server 3 of a company is received through the communication I/F 42 (Step S41).

When the electronic receipt information is received (Step S41; Yes), the electronic receipt management section 412 of the electronic receipt management server 4 stores the electronic receipt information of the company in the electronic receipt management region 43a of the storage unit 43 (Step S42). Subsequently, the electronic receipt transmission section 413 transmits the electronic receipt information stored in Step S42 to the transmission destination (the mobile terminal 7) which is managed in correlation with the member code of the electronic receipt information, such that the mobile terminal 7 can display the electronic receipt information (Step S43), and returns to Step S41.

In addition, when there is an inquiry of the electronic receipt information from the mobile terminal 7 (Step S41; No→Step S44; Yes), the electronic receipt transmission section 413 of the electronic receipt management server 4 extracts the electronic receipt information which is stored in the electronic receipt management region 43a according to the content of the inquiry (Step S45), and then transmits the electronic receipt information to the mobile terminal 7 which has transmitted the inquiry, such that the mobile terminal 7 can display the electronic receipt information (Step S46), and returns to Step S41.

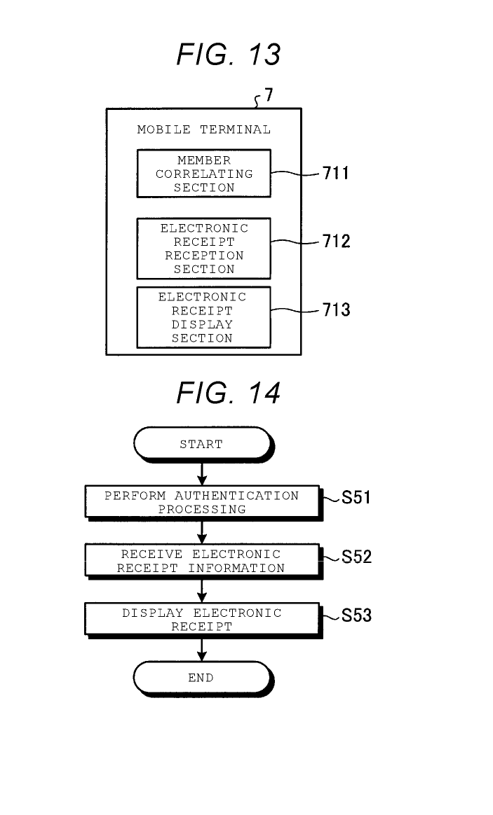

Next, a flow of the electronic receipt reception processing which is performed when the control unit 71 of the mobile terminal 7 executes the electronic receipt correspondence program 75a and a flow of the electronic receipt display processing which is performed when the control unit 71 of the mobile terminal 7 executes the electronic receipt displaying program 75b will be described with reference to FIG. 13 to FIG. 15.

As illustrated in FIG. 13, when the electronic receipt correspondence program 75a and the electronic receipt displaying program 75b are executed by the mobile terminal 7, modules including a member correlating section 711, an electronic receipt reception section 712, and an electronic receipt display section 713 are generated. As actual hardware, the CPU of the control unit 71 reads the electronic receipt correspondence program 75a and the electronic receipt displaying program 75b from the storage unit 75 and executes the programs, and thus each of the sections described above is loaded on the RAM, and the member correlating section 711, the electronic receipt reception section 712, and the electronic receipt display section 713 are generated on the RAM.

The member correlating section 711 correlates the member code of a predetermined shopper. The electronic receipt reception section 712 receives the electronic receipt information from the electronic receipt management server 4. The electronic receipt display section 713 displays the electronic receipt information received by the electronic receipt reception section 712 on the display unit 73.

As illustrated in FIG. 14, first, the member correlating section 711 of the mobile terminal 7 accesses the electronic receipt management server 4 and performs the authentication processing by inputting the member code and the password (Step S51). As a result, the mobile terminal 7 is correlated with a member code of the predetermined shopper.

After the authentication, the electronic receipt reception section 712 of the mobile terminal 7 receives the electronic receipt information associated with the input member code, which is stored in the electronic receipt management region 43a of the electronic receipt management server 4 (Step S52). Here, the electronic receipt information may be received by an email.

Next, the electronic receipt display section 713 of the mobile terminal 7 displays an electronic receipt corresponding to the electronic receipt information received by the electronic receipt reception section 712 or the like on the display unit 73 (Step S53), and terminates the processing.

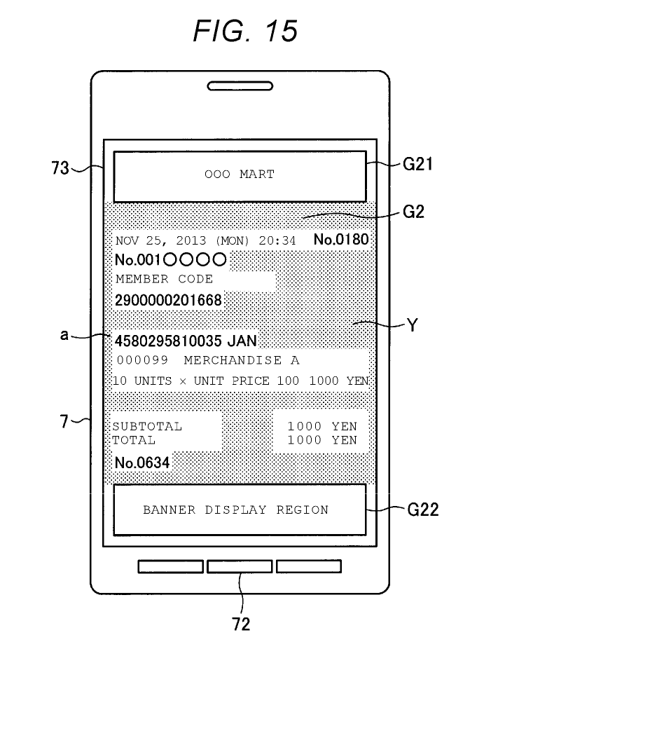

FIG. 15 illustrates an example of an electronic receipt G2 displayed on the display unit 73 of the mobile terminal 7. The electronic receipt G2 is displayed in the same layout or content as that of the receipt printed on the paper. In addition, in the electronic receipt G2, it is possible to select merchandise a, which is merchandise purchased, using a cursor following the input of the operation unit 72. In addition, in FIG. 15, a shop name logo region G21 displaying a logo of a shop name or a banner display region G22 displaying advertisement or the like are included in the electronic receipt G2.

In addition, in the present embodiment, when the flag X for notification (alarm) is added (validated), the electronic receipt display section 713 of the mobile terminal 7 changes a display mode (for example, a background color) of the electronic receipt G2, so as to facilitate the confirmation of the purchased merchandise. For example, by displaying a background Y of the electronic receipt G2 in an orange color, the user (customer) is notified that there is an alert message.

However, the configuration to provide an alert message is not limited to the above method. For example, when the flag X for notification is validated in association with a predetermined element for which the notification is necessary, the electronic receipt display section 713 of the mobile terminal 7 may change a color of a target character (in an example illustrated in FIG. 15, the number of merchandises A “10 units”), and notify the user (customer) that there is an alert message.

Furthermore, after the electronic receipt G2 of which the display mode (for example, the background color, the character color, or the like) is changed on the display unit 73 of the mobile terminal 7, if the operation unit 72, which is a touch panel, is operated, the operation may indicate that the confirmation has been performed by the operator. In this case, the electronic receipt display section 713 of the mobile terminal 7 may delete the changed display mode (for example, the background color, the character color, or the like) from the electronic receipt G2.

In the present embodiment, it is not necessary that a display mode of the electronic receipt conforms to the image of the receipt printed on the paper. However, the electronic receipt is used instead of the paper receipt, and can be a proof of a purchase transaction. Therefore, the displayed electronic receipt preferably includes following information, such that it can be used for a proof of a purchase transaction.
Store Name
Purchased Date and Time
Purchased Merchandise Specification
Sales Total Amount
Cash Register Number
Transaction Number

Furthermore, when a plurality of electronic receipt information items is received, a selection screen through which one of the electronic receipts to be displayed may be selected based on a purchase date, a company code, and the like which are included in the electronic receipt information. In this case, the electronic receipt display section 713 displays the electronic receipt selected through the selection screen on the display unit 73.

According to the present embodiment, when the notification related the predetermined element in the receipt information is determined to be necessary during the conversion from the receipt information into the electronic receipt information in the POS terminal 1, the flag for notification is validated and is added to the electronic receipt information. Then, the electronic receipt information is transmitted to the mobile terminal 7 correlated with the member code of the consumer in the electronic receipt management server 4, and the mobile terminal 7 displays the electronic receipt G2. By displaying the background Y of the electronic receipt G2 in an orange color, it is possible to notify the consumer (customer) that any event occurs. In addition, for example, by changing the character color of the predetermined element for which the notification is necessary, it is possible to notify the consumer (customer) that any event related to the predetermined element occurs.

In the embodiment described above, the control unit 11 of the POS terminal 1 (receipt information output section 112) converts the receipt information into the electronic receipt information, but the configuration is not limited thereto, and the printer 13 of the POS terminal 1 may performs the conversion processing from the receipt information into the electronic receipt information. Specifically, a printing control device (not illustrated) controlling printing which is provided in the printer 13 may function as the receipt information output section 112. In this case, when it is determined that the member code is not included in the receipt information which is generated and input in the control unit 11 of the POS terminal 1 (receipt information generation section 111), the printing control device of the printer 13 prints out the paper receipt. In contrast, when it is determined that the member code is included in the receipt information which is generated and input in the control unit 11 of the POS terminal 1 (receipt information generation section 111), the printing control device of the printer 13 converts the receipt information into the electronic receipt information. Further, when it is determined that the notification related to the predetermined element in the receipt information is necessary, the printing control device of the printer 13 adds the flag X for notification (alarm) to the electronic receipt information. The printing control device of the printer 13 then transmits the generated electronic receipt information to the electronic receipt server 3 through the communication I/F 16 of the POS terminal 1.

In addition, in the embodiment described above, the member code or the like is acquired by using the code scanner 15, but the configuration is not limited thereto. For example, the member code or the like maybe acquired using other methods. Specifically, the POS terminal 1 and the mobile terminal 7 include a near field communication unit such as Near Field Communication (NFC) or Bluetooth (registered trademark), and the member code or the like may be transmitted and received through the near field communication. In this case, the mobile terminal 7 stores the member code or the like in the storage unit 75, an IC tag (not illustrated), or the like.

In addition, in the embodiment described above, the member code or the like is acquired from the mobile terminal 7, but the configuration is not limited thereto. For example, the member code or the like may be acquired from a medium such as an IC card or a magnetic card which is able to contain the member code. Furthermore, when the IC card is used, the POS terminal 1 may include a reading/writing unit such as an IC card reader and writer. In addition, when the magnetic card is used, the POS terminal 1 may include a card reader/card writer of the magnetic card or the like.

In addition, in the embodiment described above, the electronic receipt server 3 is located in the head office P2, but the configuration is not limited thereto. For example, the electronic receipt server 3 for the store P1 maybe located in the store P1. In this case, the POS terminal 1 outputs the electronic receipt information to the electronic receipt server 3 which is connected to the network N1 in the store, and the electronic receipt server 3 transmits the electronic receipt information to the electronic receipt management server 4 through the network N1 in the store P1 and the network N2.

In addition, in the embodiment described above, the electronic receipt information generated by the POS terminal 1 is output to the electronic receipt management server 4 through the electronic receipt server 3, but the configuration is not limited thereto. For example, the electronic receipt information may be directly output to the electronic receipt management server 4 by accessing the electronic receipt management server 4 from the POS terminal 1 through the network N3.

In addition, in the embodiment described above, the mobile terminal 7 receives the electronic receipt information through the electronic receipt management server 4, but the configuration is not limited thereto. For example, the electronic receipt information may be directly received from the POS terminal 1. In this case, the POS terminal 1 outputs the generated electronic receipt information to the mobile terminal 7 which is connected through the network N1 in the store P1 or a near field communication unit (not illustrated). In addition, in this case, the authentication processing may be performed by the POS terminal 1.

In addition, in the embodiment described above, the merchandise data file is stored in the POS terminal 1, but the configuration is not limited thereto. For example, the merchandise data file may be stored in the store server 2 to be referable from the POS terminal 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A register, comprising:
a code scanner configured to optically read a code symbol;
a printer configured to print a paper receipt and having a cutter to cut off the paper receipt;
a communication interface configured to transmit an electronic receipt; and
a controller configured to
generate receipt data in a non-structured data format compatible with printing of the paper receipt by the printer,
convert the receipt data in the non-structured data format to an electronic receipt in a structured data format, when a code symbol of a customer code is read by the code scanner,
set an indicator in the electronic receipt as a structured element, when a structured element of the electronic receipt is determined to satisfy a predetermined condition, and
control the communication interface to transmit the electronic receipt in which the indicator is set.

2. The register according to claim 1, further comprising:
an operation panel, wherein
the controller coverts the receipt data in the non-structured data format to the electronic receipt in the structured data format, in response to an operation of a key on the operation panel to command cut-off of the paper receipt.

3. The register according to claim 1, wherein
the controller is configured to control the printer to print the paper receipt based on the receipt data and cut off the paper receipt, when no code symbol of a customer code is read by the code scanner.

4. The register according to claim 1, wherein
the electronic receipt also includes the customer code as a structured element.

5. The register according to claim 1, wherein
the controller sets the indicator in association with the structured element that is determined to satisfy the predetermined condition.

6. The register according to claim 1, wherein
the predetermined condition is determined to be satisfied when a value of a number of a purchased product indicated by a structured element is greater than a threshold value.

7. The register according to claim 1, wherein
the predetermined condition is determined to be satisfied when a value of a purchase date indicated by a structured element is greater than a threshold value.

8. The register according to claim 1, wherein
the predetermined condition is determined to be satisfied when a structured element indicative of a predetermined product is included in the electronic receipt.
